(19) United States
(12) Patent Application Publication
(10) Pub. No.: US 2025/0190289 A1
(43) Pub. Date: Jun. 12, 2025

(54) INTELLIGENT EVENT STREAMING GENERATOR FOR MICRO-SERVICES BASED ON SYNCHRONOUS MESSAGING FRAMEWORKS

(71) Applicant: SAP SE, Walldorf (DE)

(72) Inventors: Vipul Khullar, New Delhi (IN); Ayush Kumar, Gorakhpur (IN); Soma Shekara Pavan Kumar Marla, Kakinada (IN)

(21) Appl. No.: 18/533,029

(22) Filed: Dec. 7, 2023

(51) Int. Cl. G06F 9/54

(52) U.S. Cl. CPC G06F 9/546

(57) ABSTRACT

In some implementations, there is a method In some embodiments, there may be provided a method that includes extracting a system landscape from a target system being converted from using synchronous application program interface calls among a plurality of entities and a database instance to using an asynchronous event messaging among the plurality of entities and the database instance; determining, based on the extracted system landscape, clusters indicative of call patterns among the plurality of entities and the database instance; and providing, using the clusters, at least one proposal to convert the system to the asynchronous event messaging among the plurality of entities and the database instance. Related systems, methods, and articles of manufacture are also disclosed.

### BACKGROUND

Systems today are preferred to be less tightly coupled, so newer systems tend use an event driven framework. In an event driven framework, different systems (or the entities within the systems) communicate via events. For example, a first entity publishes an event containing a result of a database call, and the event can be consumed by one or more other entities, rather than have the first entity make an application program interface (API) call directly to one of the other entities to provide the result of the database call. This decoupling provided by the event driven framework allows entities to no longer know each other as is the case with an application program interface API call.

### SUMMARY

In some embodiments, there may be provided a method that includes extracting a system landscape from a target system being converted from using synchronous application program interface calls among a plurality of entities and a database instance to using an asynchronous event messaging among the plurality of entities and the database instance; determining, based on the extracted system landscape, clusters indicative of call patterns among the plurality of entities and the database instance; and providing, using the clusters, at least one proposal to convert the system to the asynchronous event messaging among the plurality of entities and the database instance.

In some variations, one or more features disclosed herein can optionally be included in any feasible combination. The plurality of entities may be comprised in at least one of a microservice or an application. The microservice of the target system may comprises a plurality of microservices. The method may include coupling to the target system to extract an identity of which of the plurality of entities calls, using the synchronous application program interface calls, one or more data entities. The synchronous application program interface calls may include calls made using a restful protocol. The synchronous application program interface calls may cause at least one of a create, a read, an update, or a delete of one or more data entities of the database instance. The calls may include calls among the plurality of entities and a plurality of database instances. The at least one proposal may include at least one of at least one code proposal and at least one structural change. The at least one structural change may include an addition of an event broker to handle event messages among the plurality of entities.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an example of a legacy microservice framework including microservices and a database instance using synchronous API based calling, in accordance with some embodiments;

FIG. 2 depicts an example of a legacy monolithic application, such as a database application instance, in accordance with some embodiments;

FIG. 3 depicts an example of a proposal provided by the intelligent event streaming generator, in accordance with some embodiments;

FIG. 4 depicts an example of a proposal provided by the intelligent event streaming generator, in accordance with some embodiments;

FIG. 5 depicts an example of a system including the intelligent event streaming generator, in accordance with some embodiments;

FIGS. 6A-6B depicts an example of a first entity in a microservice and a second entity of another microservice, in accordance with some embodiments;

FIG. 7 depicts an example of clusters formed based on extracted system landscape information, in accordance with some embodiments;

FIG. 8 depicts an example of a read operation detected from a microservice entity, in accordance with some embodiments;

FIGS. 9AA, 9AB, 9BA, and 9BB depict metadata which is scanned to identify the internal entities that expose an API, in accordance with some embodiments;

FIG. 10 depicts another example of a system including an intelligent event streaming generator, in accordance with some embodiments;

FIGS. 11A-11B, 12A-12B, and 13 depict examples of microservices and their corresponding code and clusters, in accordance with some embodiments;

FIG. 14A depicts a block diagram illustrating a computing system, in accordance with some example embodiments; and

FIG. 14B depicts an example of a process used to convert a target system from synchronous application program interface calls to asynchronous event messaging, in accordance with some embodiments.

When practical, similar reference numbers denote similar structures, features, or elements.

### DETAILED DESCRIPTION

Building an event driven framework requires a substantial design effort (e.g., determining the right use cases, generating artifacts, writing code, and/or the like). In the case of a legacy system, transitioning from synchronous application program interface (API) calls to an event driven framework may require breaking the legacy system into one or more small microservices or segments, each of which can communicate via events in the event based framework.

In some embodiments, there is provided an intelligent event streaming generator (IESG) that couples to an existing legacy system and, based on for example landscape information about the legacy system (e.g., mapping of API calls, database instance(s) being accessed, and/or the like) may propose changes to convert to the event-driven based microservices framework. The legacy system may comprise a microservice using synchronous API calls (e.g., in accordance with a restful protocol) and/or a monolithic application using synchronous API calls. As used herein, the “event driven” microservices framework refers to a framework that asynchronously communicates among microservices using one or more events. In an event driven framework for example, a first microservice may produce an event and publishes the event to an event mesh or router, which makes the event available to one or more other “consumer” microservices.

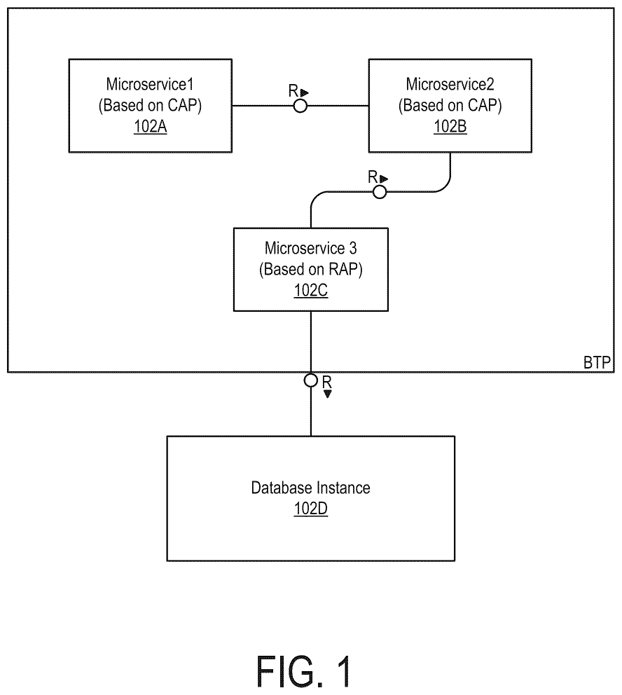

FIG. 1 depicts an example of a legacy microservice framework including microservices 102A-C and a database instance 102D using synchronous API based calling. In this example, the first microservice 102A uses a synchronous API call (e.g., a restful protocol) to the second microservice 102B, while the third microservice 102C reads the database instance 102D using another synchronous API call and then reads the second microservice 102B via another API call. FIG. 1 shows the tight coupling of the microservices and, in particular, the API based calls require the microservice to have knowledge of the API being called.

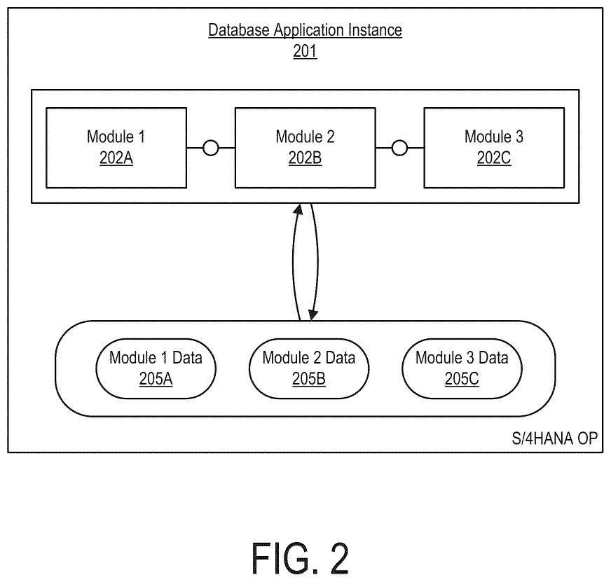

FIG. 2 depicts another example of a legacy monolithic application, such as a database application instance 201. In the example of FIG. 2, the modules 202A-C of the database application instance 201 communicate amongst themselves using synchronous API calls, and API calls are also made to the corresponding module data 205A-C at the persistence layer of the database application instance. Like FIG. 1, FIG. 2 shows the tight coupling of the monolithic application, and in particular, the API based calls require knowledge of the target modules being called.

In some embodiments, the intelligent event streaming generator (IESG) may couple to a target system, such as the synchronous API call based microservice system of FIG. 1 and/or the synchronous API call based monolithic system of FIG. 2. The coupling allows the IESG to extract (e.g., obtain, learn, etc.) information regarding the landscape of the corresponding target system. Moreover, the information regarding the landscape of the corresponding target system may enable the IESG to automatically provide one or more proposals on how the target system can be converted to a framework using the asynchronous calls of the event driven architecture. The proposals may take the form of structural changes (e.g., introducing event brokers, introducing an event mesh, etc.) and/or code changes to the microservice or application. The proposals may be used to convert the target system into an event based microservice(s) system-achieving thus a loose coupling.

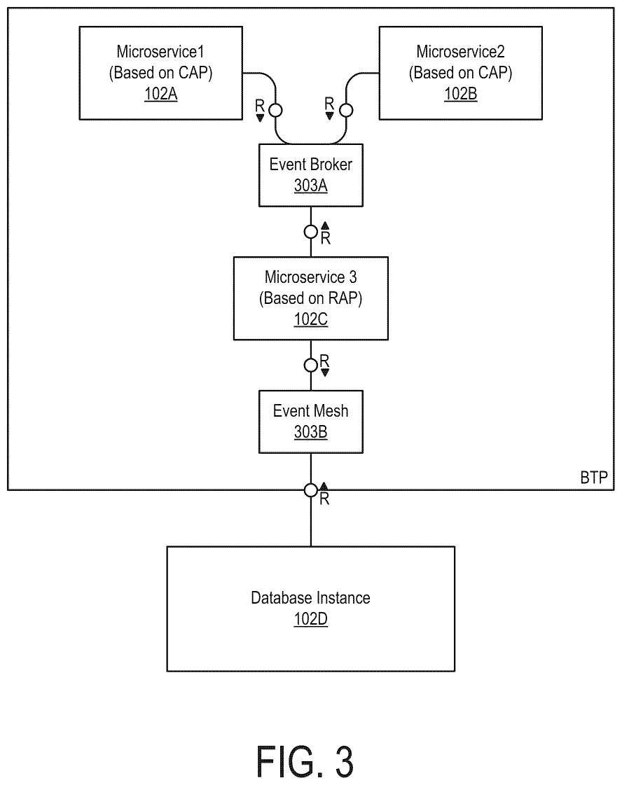

FIG. 3 depicts an example of a proposal provided by the IESG, in accordance with some embodiments. FIG. 3 is similar to FIG. 1 but the IESG couples to the system of FIG. 1 and extracts the system landscape information about the system and then proposes a structural change in the form of the addition of an event broker 303A between the microservices 102A-C to handle events. The event broker mediates the communication of events (e.g., event messages) among the microservice 102A-C. The IESG also proposes the addition of an event mesh 303B between microservice 102C and the database instance 102D. The event mesh is a layer (e.g., of one or more event brokers) that allows events from one application to be dynamically routed and received by any other application. In the example of FIG. 3, the IESG would also propose code changes to the code of target system, such that the microservice can use the event broker for messages.

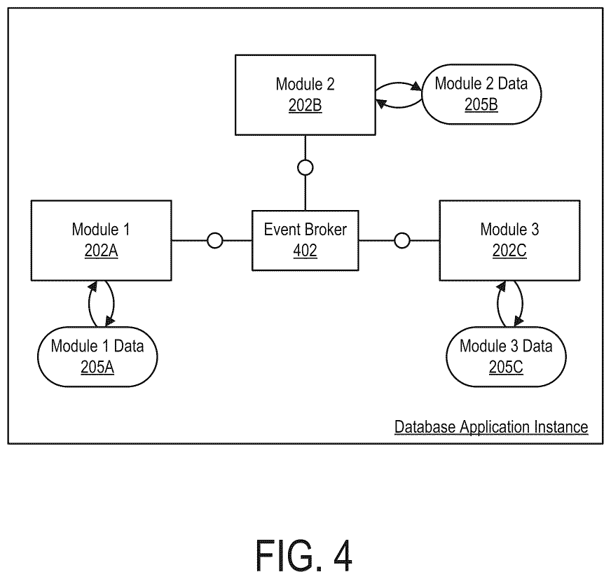

FIG. 4 depicts an example of a proposal provided by the IESG, in accordance with some embodiments. FIG. 4 is similar to FIG. 2 but the IESG couples to the system of FIG. 2 and extracts system landscape information about the system and then proposes a structural change in the form of the addition of an event broker 402 among the modules 202A-C and proposes the modules 202A-C to access their corresponding module data 205A-C directly. In the example of FIG. 3, the IESG would also propose code changes to the code of target system, such that the microservice can use the event broker for messages.

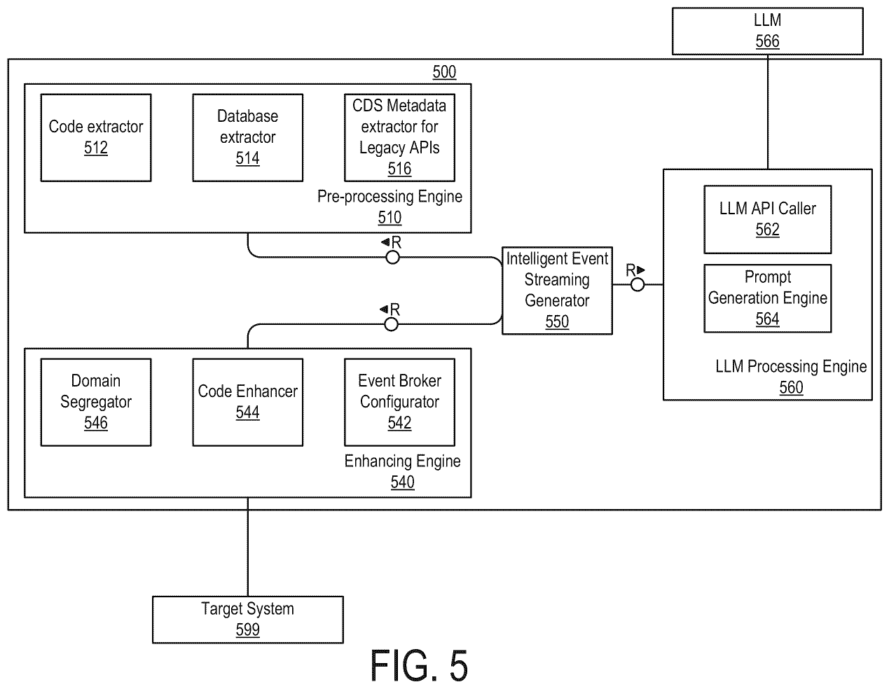

FIG. 5 depicts an example of a system 500 including the IESG 550, in accordance with some embodiments. The system 500 further includes a pre-processing engine 510 for extracting system landscape information about a target system 599 being converted from a legacy synchronous based API call based framework (as in the examples of FIGS. 1 and 2) to an event driven microservices framework.

Moreover, the system 500 includes an enhancing engine 540 that generates one or more proposals to convert to the legacy target system 500 to the event driven microservices framework. As noted, the proposals may be in the form of structural changes, code changes, and/or schema changes to a database instance.

Alternatively, or additionally, the system 500 may include or be coupled to a large language modelling (LLM) processing engine 560 configured to prompt a user to provide input regarding the conversion and decoupling. For example, the LLM processing engine may include a LLM API caller 562 that calls an external LLM with prompts and responses from an end user interacting with a prompt generation engine 564. For example, the prompt may ask the end user about the domain (if specified) for converting the legacy system to event driven architecture or may ask for any architecture diagrams or documents for the new event driven based microservices. The system 500 including the IESG 550 may thus use the LLM, which is a form of a machine learning model, such as Generative Artificial Intelligence (AI), to assist in the generation of proposals to convert the legacy target system to an event based framework. In some embodiments, LLM processing will be performed using the LLM processing engine. Alternatively, or additionally, the ML model(s) may be used for code extraction, database schema extraction (which can involve natural language processing models tuned specific code styles), and/or other tasks at system 500.

To illustrate further, the system 500 (which includes the IESG 500) may couple to the target system 599, and may then extract (e.g., obtain, monitor, learn, etc.) target system landscape information about the microservice entities at the target system, database instances at the target system, API calls among the microservices (or their entities) at the target system, and/or API calls among the microservices (or their entities) to the database instance(s) including what data elements are being called (or requested) at the target system. Alternatively, or additionally, the target system landscape information may include a package structure (e.g., a structure of documents, such as contracts), individual classes (e.g., actual code where API calls are made), a core data services service layer (e.g., contracts execution plan), and/or all the inbound and outbound APIs.

The IESG 550, based on the extracted target system landscape information, may propose one or more changes to the synchronous API calling of the target system 599 (e.g., a microservice and/or a monolithic application) to convert target system 599 into an asynchronous event messaging based microservice. In a system including a synchronous event messaging based microservice and a synchronous event messaging based monolithic application, the IESG 550 may first process the synchronous API calling of the microservice into an asynchronous event messaging based microservice and then make proposals to covert the monolithic application into an event-driven application(s) with the proposed new structure.

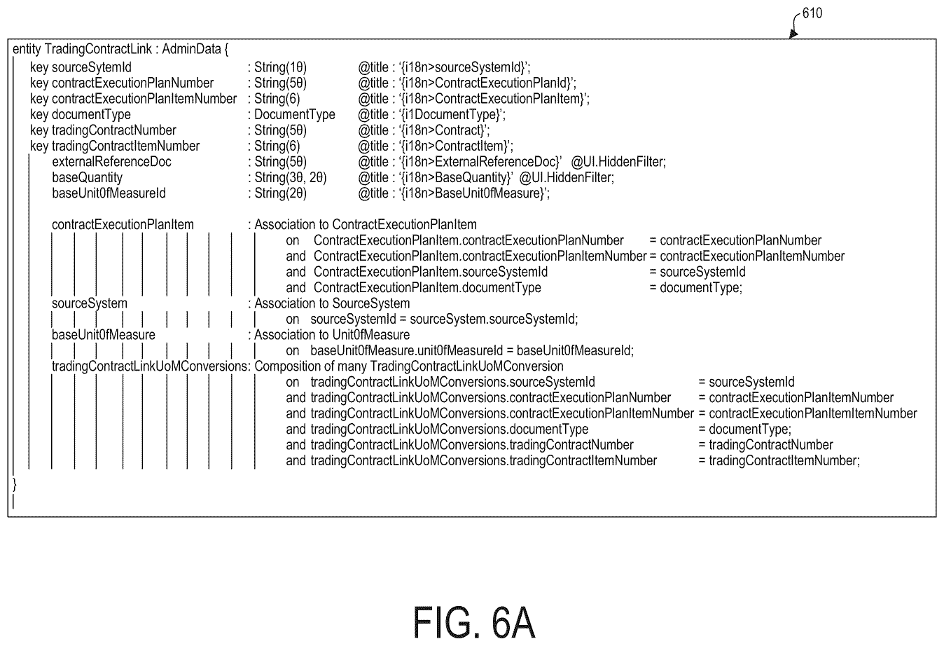

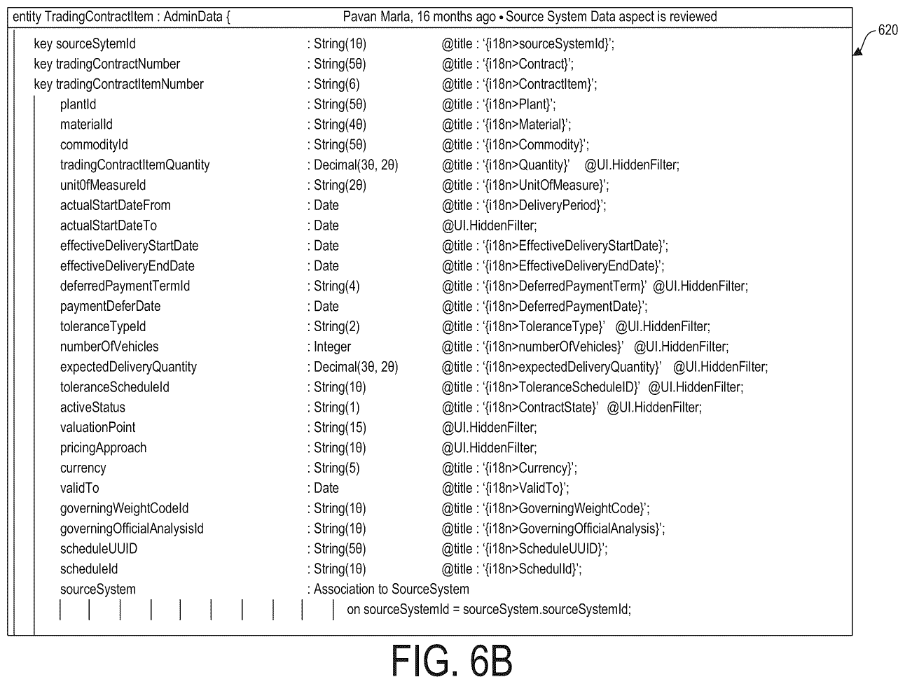

As noted, the pre-processing engine 510 may be used to extract target system landscape information about the target system 599. In some embodiments, the pre-processing engine includes a code extractor 512. The code extractor 512 may scan the target system for code associated with a microservice or a monolithic application to determine the API calls being made within (or by) the target system, the entity being called, the entity calling, what data (e.g., data objects or data entities at a database instance) are being exchanged in the call, and/or the like. In a microservice architecture, an entity represents a combination of data and logic (e.g., behavior), and the entity has an identity. FIGS. 6A-6B depicts an example of a first entity 610 in a microservice and a second 620 entity of another microservice. These entities are scanned as part of the extraction of system landscape information about the microservice.

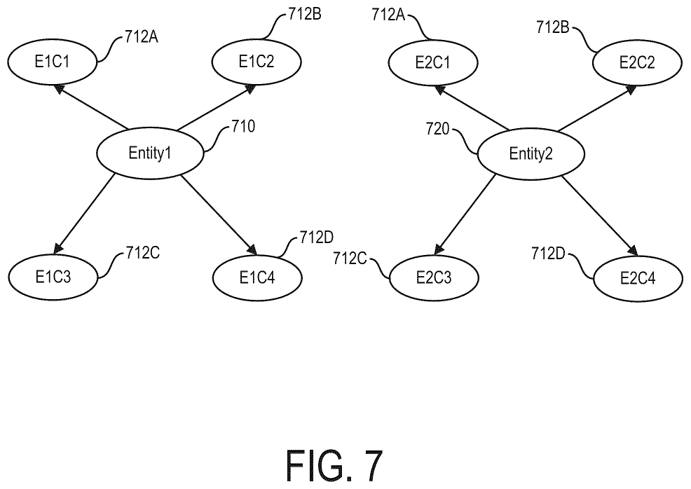

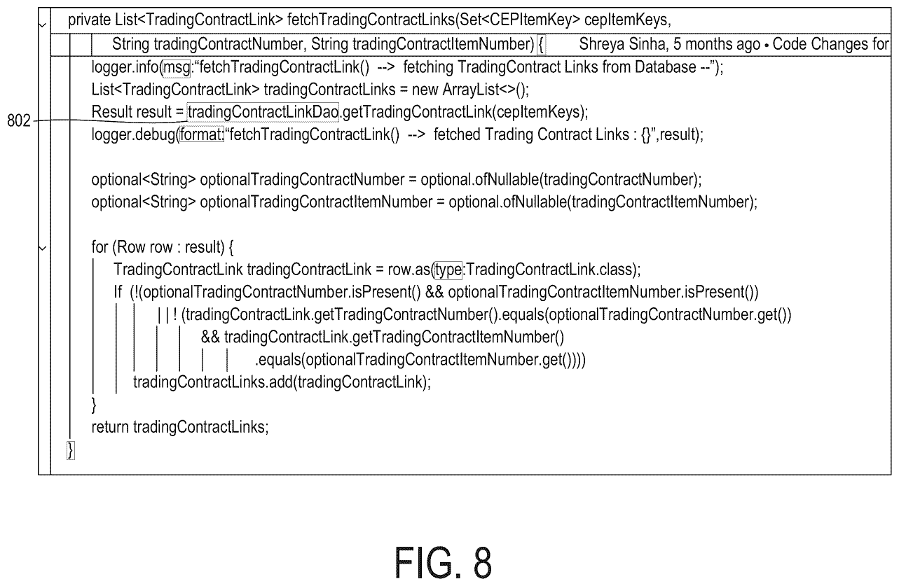

Referring again to FIG. 5, the code extractor 512 may for example scan API related code in a microservice, such as code for restful access protocol and/or other synchronous API calling protocols, to identify the call structure among the microservices and other entities, such as databases, applications, and/or the like. Specifically, the code extractor 512 may scan the API related code classes and look for locations where there are calls or any form of creating, reading, update, or deleting (CRUD) of an entity, such as a database instance and/or the like. The CRUD operations may be mapped to a cluster, such as the clusters depicted at FIG. 7. This mapping of the CRUD enables identifying at the clusters when microservices share the same database instance, rather than the microservices each having a separate and isolated database instance. These clusters enable the code and/or structural changes to keep the existing call patterns in the event driven messaging framework and/or group microservices (or their entities) in a certain group or a certain domain. FIG. 8 depicts an example of a read operation 820 detected from a microservice entity.

Referring again to FIG. 5, the pre-processing engine 510 includes a database extractor 514. The database extractor obtains information regarding what database instances are being accessed and the data elements (e.g., data objects, data entities, and/or the like stored at a database instance) being accessed. For example, entities may be defined with a predetermined extension (e.g., .cds or other extension), so all the files that end with the predetermined extension can be scrapped from the microservices to identify common data elements. Once that is done, a cluster may be created representing the associated files having the predetermined extension (e.g., .cds files) and common fields among the files. Alternatively, or additionally, a database entity may be referenced using the entitiyName.class, which can be referenced back to a cluster. This clustering may be performed using machine learning, so it learns to cluster the as shown in the example of FIG. 7.

In some embodiments, the pre-processing engine 510 includes a core data services (CDS) metadata extractor 516. The CDS metadata extractor 516 may scan and obtain the identity of core data services that are exposed by one or more microservices via for example a restful API. The CDS metadata extractor 516 may tokenize the database layer. For example, the core data service (e.g., “.cds”) files from the target system's microservices may be extracted, tokenized, and added as a dependency to the clusters, such that the tokenized data is placed into a cluster with an entity's name as an identifier. This extraction, addition, and tokenization process may be repeated for some if not all of the microservices to create respective tokens and clusters. The CDS metadata extractor 516 may create a graph of the clusters, which may be persisted. The clusters (and/or their graphs) may be used to identify the bounded context for the microservices. The bounded content enables analyzing the entities to determine which entities access what data at a database instance. For example, whether multiple entities access the same data element in a database instance, microservice, and/or the like.

FIG. 7 depicts an example of the clusters. In the example of FIG. 7, the first entity 710 forms a first cluster which depicts that the first entity accesses a first data element (C1) 712A, a second data element 712B (C2), a third data element 712C (C3), and a fourth data element 712D at a database instance. The second entity 720 forms a second cluster which depicts that the second entity access the first data element (C1) 712A, the second data element 712B (C2), the third data element 712C (C3), and the fourth data element 712D at the database instance. These clusters may be formed for some if not all of the entities of the microservice to enable determining the context of the microservice. The context of a microservice indicates what data is being accessed by what entities of the microservice.

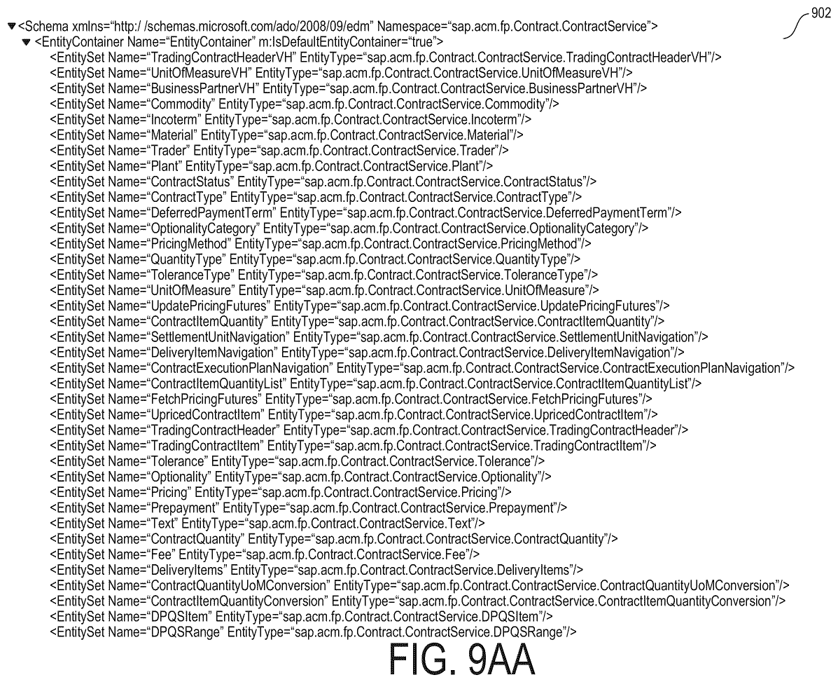

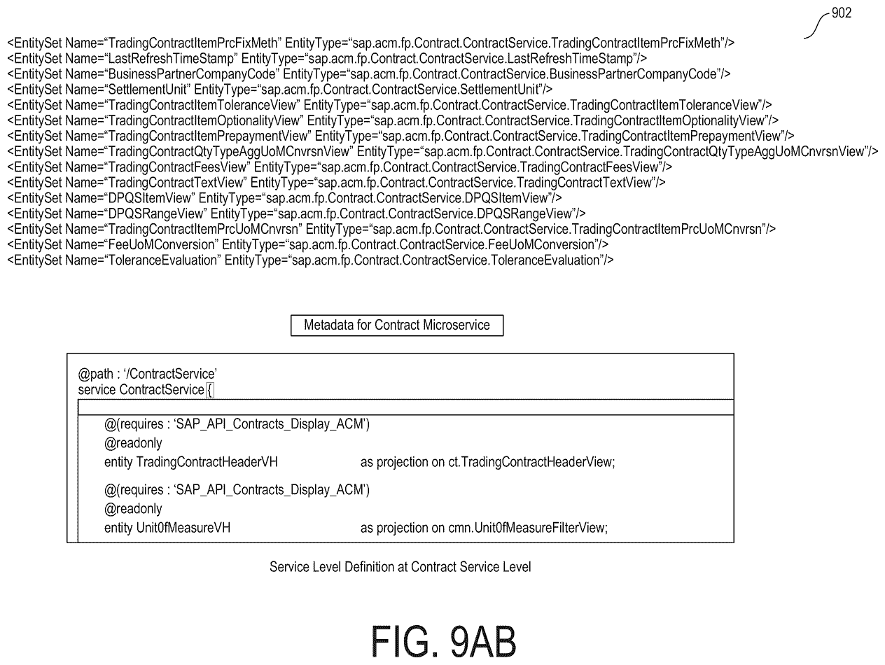

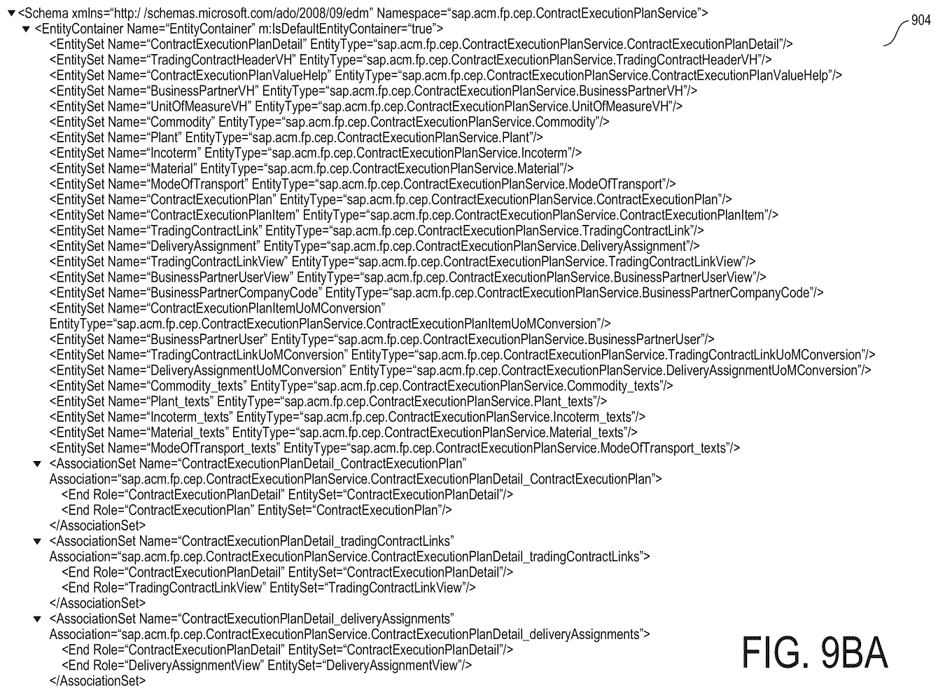

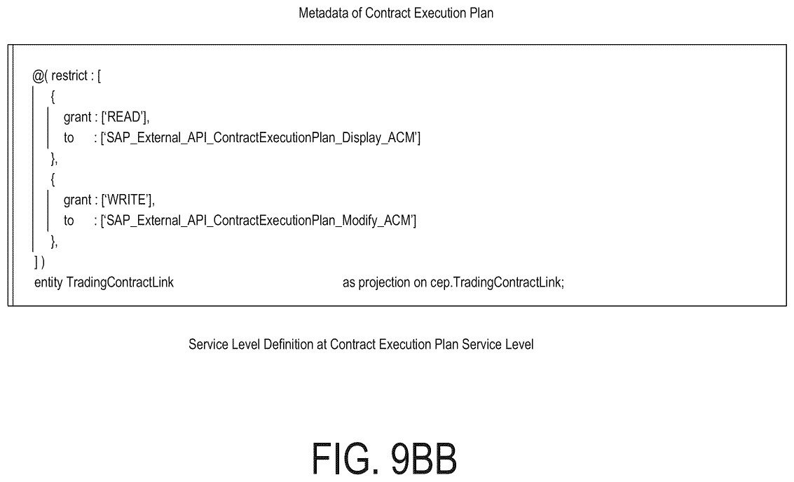

FIGS. 9AA, 9AB, 9BA, and 9BB depict metadata which is scanned to identify the internal entities at a microservice that expose an API. This scanning enables identifying APIs that are being exposed to other microservices or applications. In the example of FIGS. 9AA-9BB, the “TradingContractHeader” 902 is a read only API that is exposed from the trading contract microservice for the other microservices to read data from the API. And, the TradingContractLink 904 in the contract execution plan microservice is a read and/or write access API that reads “TradingContractHeader” 902 to update the information. When the system 500 finds the delta based on the clusters created for a particular entity (the “delta” refers to how close any two clusters are from two different set of microservices, so the closer the clusters are the more overlap is expected and hence the delta provides an indication to add events for the entities present in the cluster). The tokens will be common in both the clusters (e.g., for TradingContractHeader in Contract Microservice and TradingContractLink in the contract execution plan), so the system may calculate the closeness (e.g., delta) of these clusters before proposing an event for these entities. The metadata information from these endpoints is extracted, and based on the entities exposed in the microservices, these attributes are tokenized mapped to the clusters, such as the clusters depicted at FIG. 7. The metadata information refers to information about the entities exposed, fields exposed for read, write, and/or the like.

When the pre-processing engine 510 extracts the system landscape information about the target system, this extracted information may be provided to the LLM processing engine 560. For example, the extracted information may be provided to an LLM API caller 562, which internally calls up a prompt for the LLM 566. The LLM 566 may accept an input directly from an end user to understand the context in which the end user wants to break the microservices into the event driven framework or extract the information from other data sources (e.g., architecture guidelines, entity relationship (ER) diagrams, etc.). The ER is a type of flowchart that illustrates how “entities” relate to each other within a system.

The prompt generation engine 564 may feed the input to the LLM API caller 562 back with the context and then based on this input context and the already available graphical clusters (see, e.g., FIG. 7) for the microservices, the LLM 566 may decide which cluster of for example two different microservices has the least delta difference with each other and the context (e.g., is an event driven call for this entity needed) that is provided by the prompt engine matches the resulted output of the previous step, at that point a first set of information may indicate possible event based communication within the two microservices.

The system 500 may generate the configuration code to convert the target system into an event driven microservice and/or may provide one or more proposals for converting these microservices to event-driven microservices. For example, the code enhancer 544 may propose code to an end-user, such as a code developer, to introduce code into a microservice, so the microservice supports events. The domain segregator 546 may propose the structure of the microservice, such as what microservices should be grouped together. And, the event broker configurator 542 may provide the event broker configuration based on for example a user's choice of broker service. The code enhancer 544 may enhance existing code with changes or proposals to convert to the event driven framework. The domain segregator 546 uses LLM inputs and propose a change in package structure with clustering or grouping of entities.

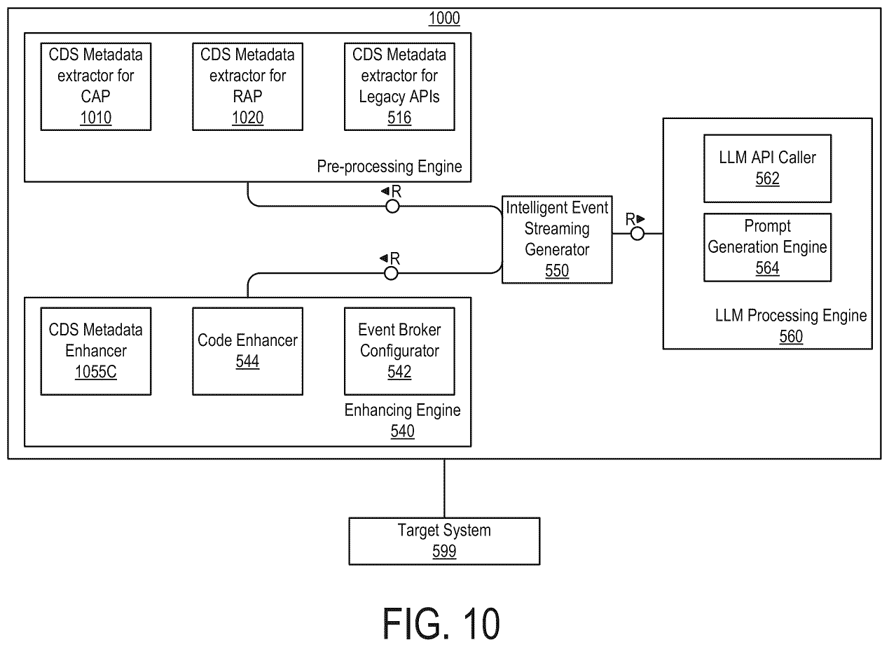

FIG. 10 depicts another example of a system including an IESG 550, in accordance with some embodiments. The system 1000 is similar in some respects to system 500 but further includes metadata extractors, such as CDS metadata extractor for RAP 1010 and CDS metadata extractor for a cloud access protocol, CAP, 1020 configured to extract metadata indicative of which entities are making calls to other entities, such as database instances. The CDS metadata enhancer 1055C provides proposals to changes to metadata to enable the transition to the event driven framework.

The following provides an example of two synchronous microservices after being processed by system 500 to form an event driven asynchronous microservices system.

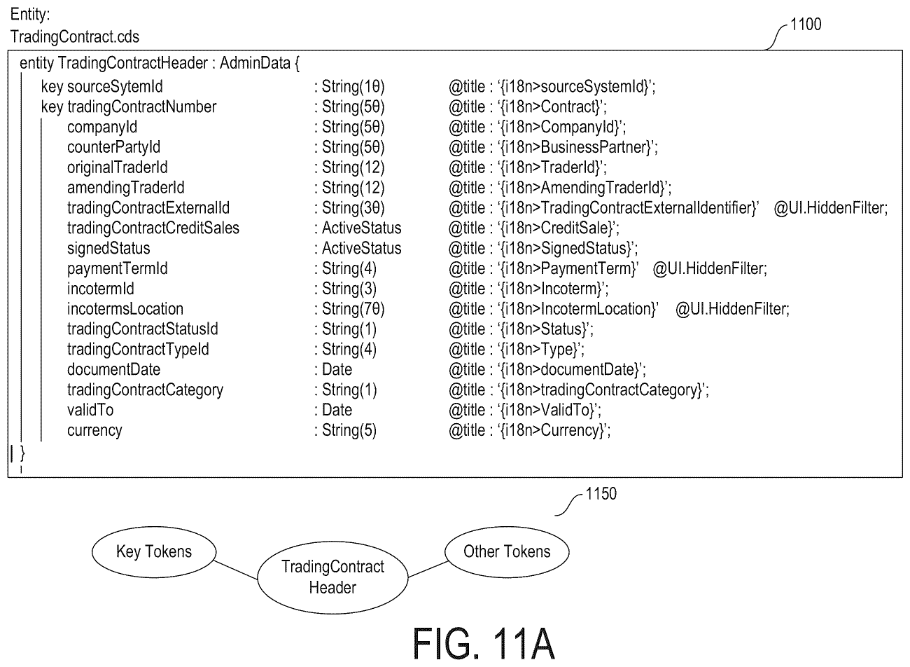

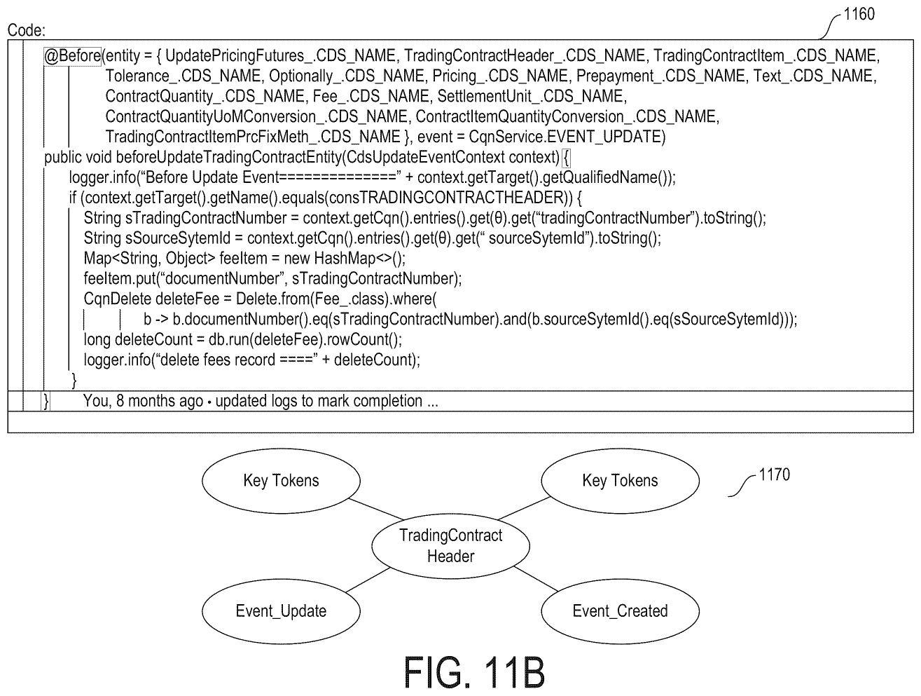

FIGS. 11A-11B depicts a first microservice, TradingContract.cds 1100. The system 500 break this microservice entity is tokenized into small tokens based on the attributes and the datatype of the attributes. For example, the tokens may include:
[“sourceSystemId:String”, “tradingContractNumber: String”] which may be consider “key tokens”; and
   [“CompanyId: String”, “counterPartId:String”,] which may be considered tokens for the attributes that can be nulled, such that the resulting graph is depicted at 1150.

The code for the microservice is depicted at 1160. Next, the API calls will be put into a cluster based on the entities on which these actions are performed. In the code 1160, the entities specified are TradingContractHeader, TradingContractItem, etc., so the cluster of 1150 expands to the cluster of 1170. The clusters are thus a mechanism to make sure that all the calls between related entities are captured and supported during the conversion of the target system to event based messaging.

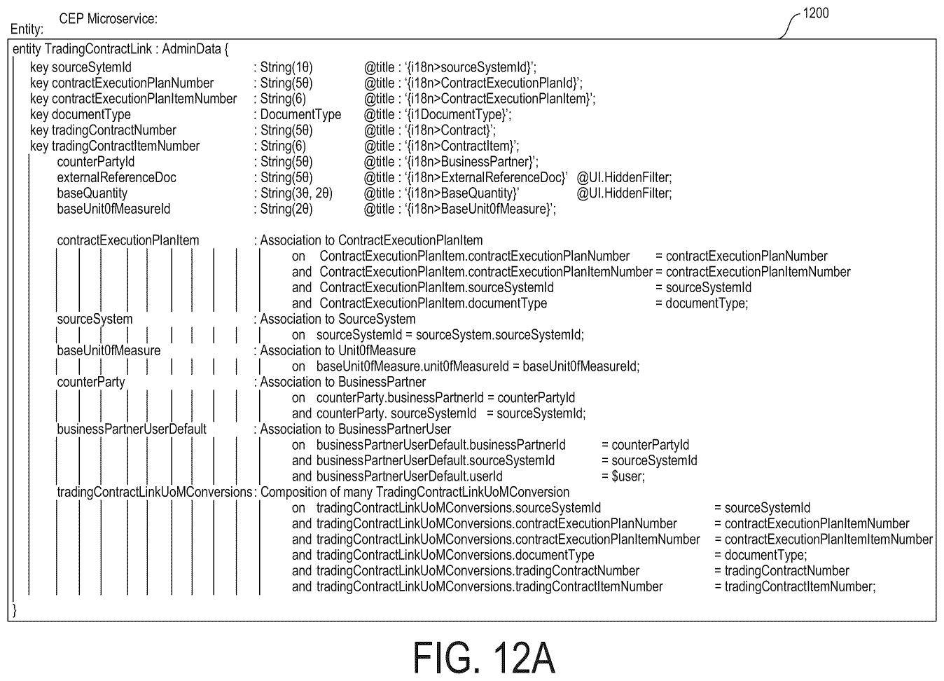

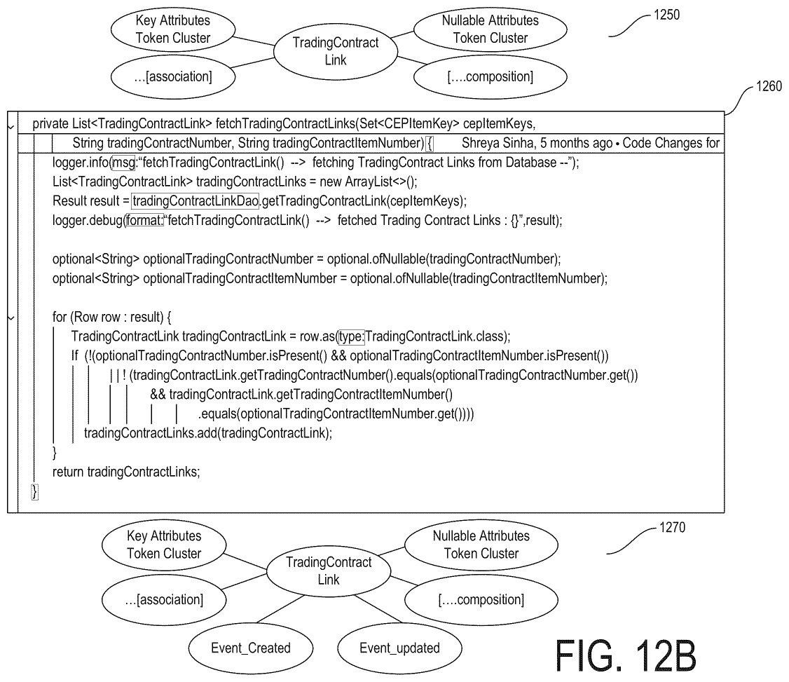

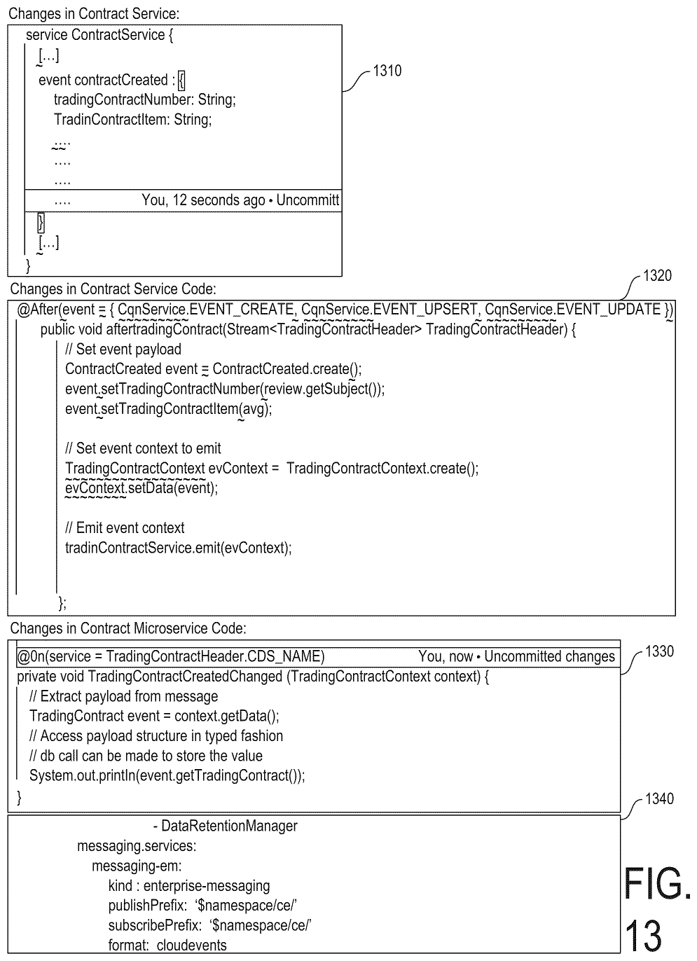

FIGS. 12A-12B depicts a second microservice, CEP.cds 1200. The system 500 break this microservice entity into small tokens based on the attributes and the datatype of the attributes as shown at tokens 1250. Now for CEP entities, clusters are formed based on key attributes and nullable attributes as shown at 1270. If both the clusters are compared, the key elements have a partial match along with the API calls which the create or update is triggered. In both microservices, trading contract information is needed at all the points. If any update is performed on the contract, the same should be accordingly updated in the CEP microservice as well which currently happens via a synchronous communication call from the Contracts microservice every time a create or update is called. Using this information, the system 500 may suggest a proposal that needs to be adapted to the existing entities and the corresponding code sections. For example, FIG. 13 depicts code proposals 1310-1340 to the first and second microservices. These changes can be implemented to convert the two microservices from synchronous API calls into an event based messaging framework.

The system 500 may propose code, structural changes, a type of an event broker that may be configured into the event based system as part of the conversion. Alternatively, or additionally, the system 500 may propose the addition of a library that can ease the job of creating topics, queues, and/or the like. Alternatively, or additionally, the type of cloud platform and/or software development kit may be proposed. Alternatively, or additionally, remote services may be to enable consumption of events directly based on the entities. After the proposal are incorporated and then executed in the target system (or a mirror development system for the target), the converted target system is able to operate its microservices using asynchronous event based messaging.

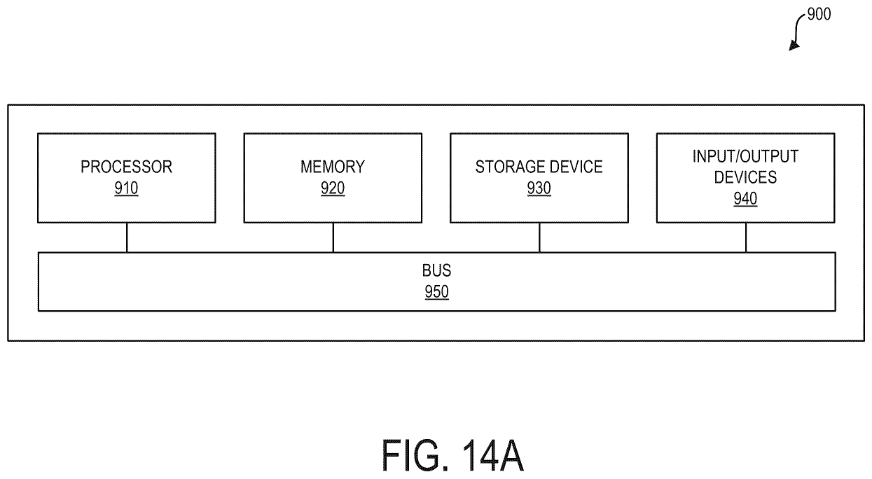

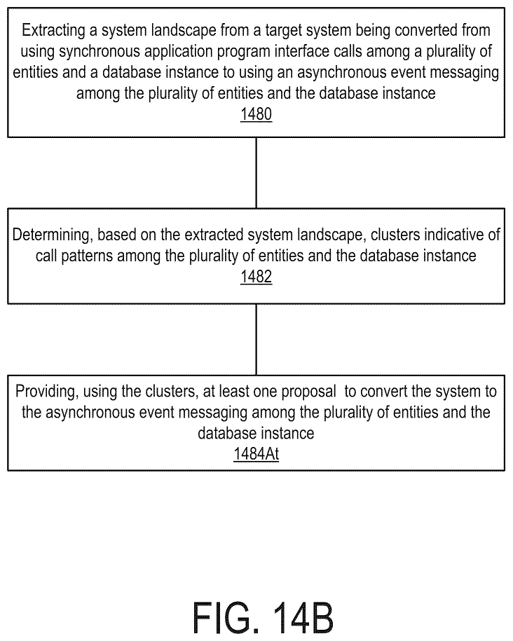

FIG. 14A depicts a block diagram illustrating a computing system 900, in accordance with some example embodiments. Referring to FIGS. 1-13, the computing system 900 can be used to implement the system 500 and/or any of the components therein. As shown in FIG. 14A, computing system 900 can include a processor 910, a memory 920, a storage device 930, and an input/output device 940. The processor 910, the memory 920, the storage device 930, and the input/output device 940 can be interconnected via a system bus 950. The processor 910 is capable of processing instructions for execution within the computing system 900. In some implementations of the current subject matter, the processor 910 can be a single-threaded processor. Alternately, the processor 910 can be a multi-threaded processor. The processor 910 is capable of processing instructions stored in the memory 920 and/or on the storage device 930 to display graphical information for a user interface provided via the input/output device 940. The memory 920 is a computer readable medium such as volatile or non-volatile that stores information within the computing system 900. The memory 920 can store data structures representing configuration object databases, for example. The storage device 930 is capable of providing persistent storage for the computing system 900. The storage device 930 can be a floppy disk device, a hard disk device, an optical disk device, or a tape device, or other suitable persistent storage means. The input/output device 940 provides input/output operations for the computing system 900. In some implementations of the current subject matter, the input/output device 940 includes a keyboard and/or pointing device. In various implementations, the input/output device 940 includes a display unit for displaying graphical user interfaces. According to some implementations of the current subject matter, the input/output device 940 can provide input/output operations for a network device. For example, the input/output device 940 can include Ethernet ports or other networking ports to communicate with one or more wired and/or wireless networks (e.g., a local area network (LAN), a wide area network (WAN), the Internet).

In some implementations of the current subject matter, the computing system 900 can be used to execute various interactive computer software applications that can be used for organization, analysis and/or storage of data in various (e.g., tabular) format (e.g., Microsoft Excel®, and/or any other type of software). Alternatively, the computing system 900 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 940. The user interface can be generated and presented to a user by the computing system 900 (e.g., on a computer screen monitor, etc.).

FIG. 14B depicts an example of a process used to convert a target system from synchronous application program interface calls to asynchronous event messaging, in accordance with some embodiments.

At 1480, a system landscape may be extracted from a target system, such as target system 599, in accordance with some embodiments. The target system is being converted from using synchronous application program interface calls (which are among a plurality of entities and a database instance) to using an asynchronous event messaging (among the plurality of entities and the database instance). The plurality of entities may be comprised in at least one microservice and/or at least one application. Alternatively, or additionally, the microservice may comprise a plurality of microservices.

To extract the system landscape information, the IESG 500 may couple to the target system 599 to extract an identity of which of the plurality of entities calls, using the synchronous application program interface calls, one or more data entities (also referred to, e.g., data object or data elements) at a database instance.

In some embodiments, the synchronous application program interface calls comprise a restful protocol, such as call made using representational state transfer (REST) protocol. The synchronous application program interface calls from a microservice or application (or an entity therein) may cause at a database instance being call a create, a read, an update, or a delete of one or more data entities of the database instance.

At 1482, clusters may be determined based on the extracted system landscape, wherein the clusters are indicative of call patterns among the plurality of entities and the database instance, in accordance with some embodiments. As noted above with respect to FIGS. 7, 11, and 12, the system landscape information may be used to form clusters that can be used to track the calls being made from a given entity at a microservice (or application) to a database instance (as well as other microservices and/or applications). The clusters thus allow tracking all of the call patterns so that the calls are still supported after the conversion from synchronous application program interface calls to asynchronous event messaging

At 1483, at least one proposal to convert the system to the asynchronous event messaging among the plurality of entities and the database instance may be provided based or using the clusters, in accordance with some embodiments. The proposal may be in the form of a code proposal, a structural change, and/or the like.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A system, comprising:
at least one processor; and at least one memory including program code which when executed by the at least one processor causes operations comprising: extracting a system landscape from a target system being converted from using synchronous application program interface calls among a plurality of entities and a database instance to using an asynchronous event messaging among the plurality of entities and the database instance; determining, based on the extracted system landscape, clusters indicative of call patterns among the plurality of entities and the database instance; and providing, using the clusters, at least one proposal to convert the system to the asynchronous event messaging among the plurality of entities and the database instance.

Example 2: The system of Example 1, wherein the plurality of entities are comprised in at least one of a microservice or an application.

Example 3: The system of any of Examples 1-2, wherein the microservice of the target system comprises a plurality of microservices.

Example 4: The system of any of Examples 1-3, further comprising: coupling to the target system to extract an identity of which of the plurality of entities calls, using the synchronous application program interface calls, one or more data entities.

Example 5: The system of any of Examples 1-4, wherein the synchronous application program interface calls comprise calls made using a restful protocol.

Example 6: The system of any of Examples 1-5, wherein the synchronous application program interface calls cause at least one of a create, a read, an update, or a delete of one or more data entities of the database instance.

Example 7: The system of any of Examples 1-6, wherein the calls comprise calls among the plurality of entities and a plurality of database instances

Example 8: The system of any of Examples 1-7, wherein the at least one proposal comprises at least one of at least one code proposal and at least one structural change.

Example 9: The system of any of Examples 1-8, wherein the at least one structural change comprises an addition of an event broker to handle event messages among the plurality of entities.

Example 10: A computer-implemented method comprising: extracting a system landscape from a target system being converted from using synchronous application program interface calls among a plurality of entities and a database instance to using an asynchronous event messaging among the plurality of entities and the database instance; determining, based on the extracted system landscape, clusters indicative of call patterns among the plurality of entities and the database instance; and providing, using the clusters, at least one proposal to convert the system to the asynchronous event messaging among the plurality of entities and the database instance.

Example 11: The computer-implemented method of Example 10, wherein the plurality of entities are comprised in at least one of a microservice or an application.

Example 12: The computer-implemented method of any of Examples 10-11, wherein the microservice of the target system comprises a plurality of microservices.

Example 13: The computer-implemented method of any of Examples 10-12, further comprising: coupling to the target system to extract an identity of which the plurality of entities calls, using the synchronous application program interface calls, one or more data entities.

Example 14: The computer-implemented method of any of Examples 10-13, wherein the synchronous application program interface calls comprise calls made using a restful protocol.

Example 15: The computer-implemented method of any of Examples 10-14, wherein the synchronous application program interface calls cause at least one of a create, a read, an update, or a delete of one or more data entities of the database instance.

Example 16: The computer-implemented method of any of Examples 10-16, wherein the calls comprise calls among the plurality of entities and a plurality of database instances

Example 17: The computer-implemented method of any of Examples 10-17, wherein the at least one proposal comprises at least one of at least one code proposal and at least one structural change.

Example 18: The computer-implemented method of claim 17, wherein the at least one structural change comprises an addition of an event broker to handle event messages among the plurality of entities.

Example 19: A non-transitory computer-readable medium including program code which when executed by at least one processor causes operations comprising: extracting a system landscape from a target system being converted from using synchronous application program interface calls among a plurality of entities and a database instance to using an asynchronous event messaging among the plurality of entities and the database instance; determining, based on the extracted system landscape, clusters indicative of call patterns among the plurality of entities and the database instance; and providing, using the clusters, at least one proposal to convert the system to the asynchronous event messaging among the plurality of entities and the database instance.

Example 20: The non-transitory computer-readable medium of Example 19, wherein the plurality of entities are comprised in at least one of a microservice or an application.

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system, comprising:
at least one processor; and
at least one memory including program code which when executed by the at least one processor causes operations comprising:
extracting a system landscape from a target system being converted from using synchronous application program interface calls among a plurality of entities and a database instance to using an asynchronous event messaging among the plurality of entities and the database instance;
determining, based on the extracted system landscape, clusters indicative of call patterns among the plurality of entities and the database instance; and
providing, using the clusters, at least one proposal to convert the system to the asynchronous event messaging among the plurality of entities and the database instance.

2. The system of claim 1, wherein the plurality of entities are comprised in at least one of a microservice or an application.

3. The system of claim 2, wherein the microservice of the target system comprises a plurality of microservices.

4. The system of claim 1, further comprising: coupling to the target system to extract an identity of which of the plurality of entities calls, using the synchronous application program interface calls, one or more data entities.

5. The system of claim 1, wherein the synchronous application program interface calls comprise calls made using a restful protocol.

6. The system of claim 1, wherein the synchronous application program interface calls cause at least one of a create, a read, an update, or a delete of one or more data entities of the database instance.

7. The system of claim 1, wherein the calls comprise calls among the plurality of entities and a plurality of database instances.

8. The system of claim 1, wherein the at least one proposal comprises at least one of at least one code proposal and at least one structural change.

9. The system of claim 8, wherein the at least one structural change comprises an addition of an event broker to handle event messages among the plurality of entities.

10. A computer-implemented method comprising:
extracting a system landscape from a target system being converted from using synchronous application program interface calls among a plurality of entities and a database instance to using an asynchronous event messaging among the plurality of entities and the database instance;
determining, based on the extracted system landscape, clusters indicative of call patterns among the plurality of entities and the database instance; and
providing, using the clusters, at least one proposal to convert the system to the asynchronous event messaging among the plurality of entities and the database instance.

11. The computer-implemented method of claim 10, wherein the plurality of entities are comprised in at least one of a microservice or an application.

12. The computer-implemented method of claim 11, wherein the microservice of the target system comprises a plurality of microservices.

13. The computer-implemented method of claim 10, further comprising: coupling to the target system to extract an identity of which of the plurality of entities calls, using the synchronous application program interface calls, one or more data entities.

14. The computer-implemented method of claim 10, wherein the synchronous application program interface calls comprise calls made using a restful protocol.

15. The computer-implemented method of claim 10, wherein the synchronous application program interface calls cause at least one of a create, a read, an update, or a delete of one or more data entities of the database instance.

16. The computer-implemented method of claim 10, wherein the calls comprise calls among the plurality of entities and a plurality of database instances.

17. The computer-implemented method of claim 10, wherein the at least one proposal comprises at least one of at least one code proposal and at least one structural change.

18. The computer-implemented method of claim 17, wherein the at least one structural change comprises an addition of an event broker to handle event messages among the plurality of entities.

19. A non-transitory computer-readable medium including program code which when executed by at least one processor causes operations comprising:
extracting a system landscape from a target system being converted from using synchronous application program interface calls among a plurality of entities and a database instance to using an asynchronous event messaging among the plurality of entities and the database instance;
determining, based on the extracted system landscape, clusters indicative of call patterns among the plurality of entities and the database instance; and
providing, using the clusters, at least one proposal to convert the system to the asynchronous event messaging among the plurality of entities and the database instance.

20. The non-transitory computer-readable medium of claim 19, wherein the plurality of entities are comprised in at least one of a microservice or an application.
